(19) United States
(12) Patent Application Publication
(10) Pub. No.: US 2012/0152372 A1
(43) Pub. Date: Jun. 21, 2012

(54) SPRINKLER WATER SAVING SYSTEM

(76) Inventors: TODD JACOBSON, CARLSBAD, CA (US); JACKIE BERKES, CARLSBAD, CA (US)

(21) Appl. No.: 12/972,514

(22) Filed: Dec. 19, 2010

(51) Int. Cl. F16K 17/36

(52) U.S. Cl. 137/78.1

(57) ABSTRACT

A sprinkler water saving system comprising: a water collector, wherein said collector includes a tray to collect a specified amount of rainwater; a neck attached beneath said tray; a base situated beneath said neck to support said tray, where said base is attached to a stationary outdoor structure to enable said tray to collect said specified amount of rainwater; and a sensor within said water collector to send a signal when said tray collects said specified amount of rainwater; and a controller, where said controller activates and deactivates a sprinkler system, based upon the status of the water collector; a plurality of components attached to said controller; and a microprocessor within said controller to operate said plurality of components, said microprocessor transmits signals for the activation and deactivation of the sprinkler system.

### BACKGROUND OF THE INVENTION

1. Field of the Invention

The present invention relates to a sprinkler system controller with a remote water collection system to send a signal to the sprinkler system controller to indicate if rain is falling thus deactivating the sprinkler system.

2. Description of Related Art

Every year thousands of dollars are unnecessarily spent on wasted water, damaged plants and oversaturated lawns. One reason for this problem is due to sprinkler systems continuing to operate during rainstorms. During rainstorms the use and necessity of a sprinkler system is obsolete and thus any of the water dispersed is wasted on an already wet lawn. Accordingly, the lawns and plants become oversaturated due to the double watering potentially causing lawn damage or even lawn death. Water conservation and waste avoidance is especially prevalent in the areas where water restrictions are in place either due to droughts or desert and arid type climates. In these areas, a homeowner must be especially aware of when they water, otherwise they might face hefty fines.

Some devices are available to detect rainfall and then control the sprinkler systems. In U.S. Pat. No. 6,452,499, a Wireless Environmental sensor system is disclosed which mounts an environmental sensor to the roof of a house to detect rainfall. If rainfall is detected the environmental sensor sends a signal to the controllable system to affect the operation of water cycles of the irrigation system. This device is useful to simply detect rainfall, but it is unclear as to how much rainfall will stop the system. If only a small amount of rain falls, then the irrigation system could still be required.

Similarly, U.S. Pat. No. 5,321,578 discloses a Rain Detector for Automatic Irrigation Systems wherein a rainwater-collection tray is mounted beneath a rainfall detector. The amount of rainwater-collection tray exposed to the elements is adjustable to vary the amount of rainfall required to signal the rainfall detector to deactivate the automatic sprinkler system. While useful, this device falls short in requiring the rainwater-collection tray and the rainfall detector to remain joined.

It would be beneficial in the art to provide a rainwater detector which detects a specified amount of water rather than simply detecting rain. It would also be desirable to provide a device that enables a water detector to be mounted to a separate location from the control unit.

### SUMMARY OF THE INVENTION

An object of the present invention is to provide a water collector that collects an amount of rainwater which, when a significant amount is received, informs a sprinkler controller to deactivate a sprinkler system.

Another object of the present invention is to provide a water saving system which comprises two components situated separate from each other to enable the water collector to mount at a most advantageous water collection location.

In view of the foregoing disadvantages inherent in the prior art, the present invention provides a sprinkler water saving system comprising: a water collector, wherein said collector includes a tray to collect a specified amount of rainwater; a neck attached beneath said tray; a base situated beneath said neck to support said tray, where said base is attached to a stationary outdoor structure to enable said tray to collect said specified amount of rainwater; and a sensor within said water collector to send a signal when said tray collects said specified amount of rainwater; and a controller, where said controller activates and deactivates a sprinkler system, based upon the status of the water collector; a plurality of components attached to said controller; and a microprocessor within said controller to operate said plurality of components, said microprocessor transmits signals for the activation and deactivation of the sprinkler system.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a water saver device in accordance with an exemplary embodiment of the present invention;

FIG. 2 depicts a perspective view of a water collector in accordance with an exemplary embodiment of the present invention; and

FIG. 3 depicts a water saver device in accordance with another exemplary embodiment of the present invention.

Like reference numerals refer to like parts throughout the description of several views of the drawings.

### DETAILED DESCRIPTION OF THE DRAWINGS

The present invention relates to a sprinkler system controller with a remote water collection system to send a signal to the sprinkler system controller to indicate if rain is falling. If the water collection system determines that it is raining, the sprinkler system is deactivated and it will not operate as programmed. The present invention is a sprinkler water saving system, which conserves irrigation water while maintaining quality landscaping and preventing oversaturation and waste. The sprinkler water saving system combines a water collector and a water saver device to detect rainfall and in turn deactivate the sprinkler system. The system is battery operated and regulates water usage in conjunction with a user's preset sprinkler timing system. The sprinkler water saving system will save the user money by not wasting water by watering in the rain, and by saving the lawn and landscaping by not over-saturating the plants.

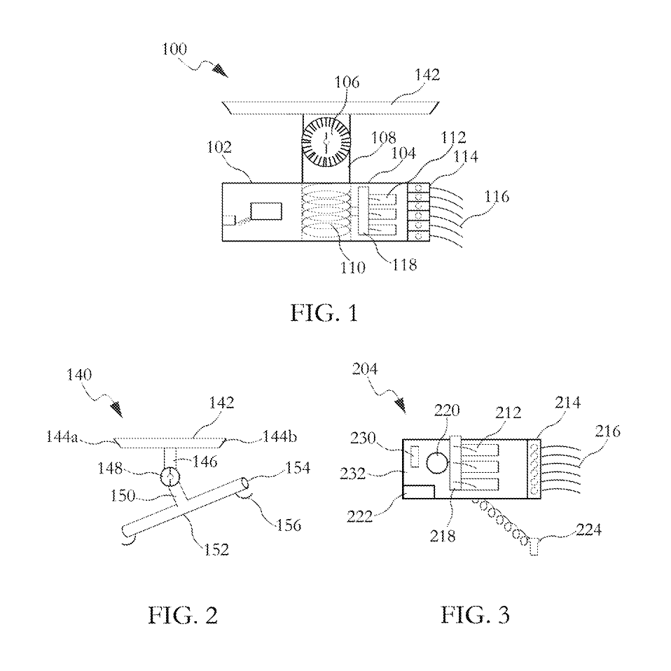

Turning now to the drawings, referring to FIG. 1, a perspective view of a water saver device (100) is shown in accordance with an exemplary embodiment of the present invention. The water saver device (100) may comprise a housing (102), a removable controller (104) and a pivot adjuster (106). The housing (102) may support and contain the various components of the water saver device (100).

The adjuster (106) may be mounted upon a plate (108) extending from a spring (110). The adjuster (106) enables the adjustment of a water collection tray (142) to accommodate for the pitch of the roof and therefore place the tray (142) in a horizontal position. The water collection tray (142) extends from the top of the plate (108) where the tray (142) allows for the collection of rain water and activates specific control functions as described below.

Turning to the removable controller (104), a plurality of components working in conjunction determine how the removable controller (104) controls the sprinkler system. The removable controller (104) may contain a microprocessor housed within the controller (104), a micro switch (112) attached to a lever (118), and an electrical connector panel (114) with a plurality of valve wires (116). The microprocessor controls the plurality of components to activate and deactivate the sprinkler system. The plurality of valve wires (116) extend from the removable controller (104) and are connected to a set of sprinkler valves housed within an external unit.

The microprocessor then deactivates the sprinkler system by controlling the plurality of valve wires (116) in not turning on the sprinkler system. Conversely, the microprocessor may activate the sprinkler system again when either the user manually resets the remote controller (104) or a reactivation signal is received from the signal processor. The reactivation signal may be sent from the sensor on the water collector when there is no longer water is in the water collector.

Referring now to FIG. 2, a perspective view of the water collector components (140) is shown in accordance with an exemplary embodiment of the present invention. The water collector components (140) may comprise a base (152), with a set of ends (154) and a set of clips (156) beneath each end (154) all of which are integrated in the housing (102). The base (152) and set of clips (156) enable the water collector (140) to attach to a stationary outdoor fixture like a roof, shutter, gate, rail or the like. The water collector (140) is integrated in the housing (102) where the collector tray (142) extends above the housing (102) as shown in FIG. 1. The clips (156) and the base (152) pinch an edge or lip of the roof to remain in place and secure during water collection.

An arm (150) extends from the base (152) where the arm (150) attaches to a pivot (148). The pivot (148) joins the arm (150) with a neck (146) to enable the two components to rotate back and forth. The pivot (148) may have a tight junction between the arm (150) and the neck (146) so that the neck (146) does not easily bend without a significant amount of force. Affixed upon the neck (146) may be a tray (142). The tray (142) may include a set of lips (144a and 144b) or edges to ensure that any contents collected into the tray (142) do not spill. The pivot (148) may adjust the tray (142) to remain parallel to the ground regardless of where the base (152) is mounted.

The tray (142) serves as a collection device for the water collector (140), wherein when it rains the tray (142) collects the falling water. As the tray (142) fills, the weight of the water will steadily increase until a predetermined weight or significant amount is obtained. The weight of the water in the tray (142) depresses the lever (118), shown in FIG. 1. Once the predetermined weight is reached the controller (104) deactivates the sprinkler system on the water saver device (100). The plurality of valve wires (116) closes the set of sprinkler valves. After the rain water evaporates, the force against the tray (142) caused by the water weight is gone and thus the controller (104) and consequently the sprinkler system is activated. Alternatively, beneath the lip (144b) or on a side of the tray near the lip (144b) may be a weight (not shown). The weight may balance the tray (142) upon the neck (146) and pivot (148) so that when the tray (142) is empty the tray (142) remains in a horizontal position.

Referring now to FIG. 3, a perspective view of alternative version of a wireless version of the controller (204) is shown in accordance with an exemplary embodiment of the present invention. Along with the plurality of components previously discussed, the controller (204) further includes a motor (220), a battery compartment (222) and a valve sensor (224). The battery compartment (222) houses a set of batteries to enable the removable controller (204) to receive power and function properly. The valve sensor (224) sends control signals to the set of sprinkler valves. The removable controller (204) deactivates the sprinkler system via use of valve sensor (224) which transmits a wireless deactivation signal to the set of sprinkler valves thus deactivates the sprinkler system until reactivation.

The controller (204) may include a signal processor (230) and a signal receiver (232). The signal receiver (232) is activated upon the status of the water collector (as described above) when a specified amount of water is collected. The signal processor (230) monitors the activity of the collection process until a specified amount of water collected within the water collector. If the water reaches a predetermined amount the signal processor (230) transfers a signal via the valve sensor (224) to deactivate the sprinkler system.

The water saver device (100) may be attached near the external unit which houses the set of sprinkler valves on a roof, gutter or fence. Regardless, the water saver device (100) coupled with the water collector (140) the sprinkler water saving system. After the water collector (140) determines that a sufficient amount of rain has fallen, it triggers a signal to the removable controller (104) to deactivate the sprinkler system. Therefore the sprinkler system will not operate unnecessarily in the rain. The sprinkler water saving system will save the user money by eliminating frivolous sprinkler use.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A sprinkler water saving system comprising:
a water collector, wherein said collector includes a tray to collect a specified amount of rainwater; a neck attached beneath said tray; a base situated beneath said neck to support said tray, where said base is attached to a stationary outdoor structure to enable said tray to collect said specified amount of rainwater; and a sensor within said water collector to send a signal when said tray collects said specified amount of rainwater; and
a controller, where said controller activates and deactivates a sprinkler system, based upon the status of the water collector;
a plurality of components attached to said controller; and
a microprocessor within said controller to operate said plurality of components, said microprocessor transmits signals for the activation and deactivation of the sprinkler system.

2. The sprinkler water saving system of claim 1, wherein said stationary outdoor structure is a roof gutter.

3. The sprinkler water saving system of claim 1, wherein said water saver device includes a valve sensor that transmits a wireless deactivation signal to the sprinkler system to deactivate the sprinkler system until reactivation.

4. The sprinkler water saving system of claim 1, wherein said neck is attached to a pivot beneath said tray to adjust said tray upon said base.

5. The sprinkler water saving system of claim 1, wherein said timer includes a digital display.

6. The sprinkler water saving system of claim 1, wherein said timer includes a dial.

7. The sprinkler water saving system of claim 1, wherein said base includes a set of clips to attach said base to said stationary outdoor structure.
